(19) United States
(12) Patent Application Publication
(10) Pub. No.: US 2007/0142992 A1
(43) Pub. Date: Jun. 21, 2007

(54) Method for improving a cruise control system

(75) Inventors: Ralph Gronau, Wetter (DE); Michel Wagner, Mainz (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/578,994

(22) PCT Filed: Nov. 12, 2004
(86) PCT No.: PCT/EP04/52934

§ 371 Date: May 11, 2006

(30) Foreign Application Priority Data
Nov. 14, 2003 (DE) 103 53 333.8
Oct. 5, 2004 (DE) 2004 048 492.9

(51) Int. Cl. G06G 7/76

(52) U.S. Cl. 701/70

(57) ABSTRACT

Disclosed is a method for improving a cruise control system in a motor vehicle having a navigation system. The cruise control system determines the possibility or necessity for the driver to take over control of the vehicle in the immediate future and the driver is alerted to the fact that a take-over is imminent or the attention of the driver is increased, when the possibility or necessity of a take-over of the vehicle control by the driver is detected. Also, the cruise control system determines if the speed of the vehicle is higher than a safe speed for the imminent driver reaction. If the speed is determined to be to high, the cruise control system gently reduces the speed of the vehicle.

### BACKGROUND OF THE INVENTION

The present invention relates to a method for improving a cruise control system.

Following assist systems which are employed more and more frequently in vehicles, active speed control systems, i.e. cruise control systems, also known as ACC (Adaptive Cruise Control), AICC (Adaptive Intelligent Cruise Control) or ICC (Intelligent Cruise Control), will gain in significance on the market because they can greatly relieve the driver in operating the vehicle. In making the driver's life easier, they can enhance driving comfort significantly. However, the consequence is that particularly high demands are placed on these systems in terms of control comfort.

In particular high-class modern vehicles mostly are equipped already with a navigation system as an assist system. Conventional speed control systems, also referred to as cruise control systems, likewise are frequently provided in these vehicles. It may be expected that ACC systems will also be used at an increasing rate in this class of vehicles.

Both assist systems, i.e. the navigation systems and the speed control systems, relieve the driver, on the one hand, while they can reduce the driver's attention with respect to incidents in traffic and steering of the vehicle, on the other hand. This is because navigation and speed control will no longer be handled directly as tasks by the operator of the vehicle. In practice, this fact can hardly be avoided and represents a major drawback of systems of this type.

Even highly developed assist systems, especially speed control systems with cruise control functions such as the ACC, AICC or ICC system, cannot assume the driver's responsibility. Rather, these systems need being constantly monitored by the driver.

### SUMMARY OF THE INVENTION

An object of the invention involves enhancing the comfort and safety of a cruise control system.

This object is achieved by a method for improving a cruise control system. The method determines that a possibility or a necessity that a driver of a vehicle takes over vehicle control in the immediate future and indicates to the driver that a take-over is imminent in the immediate future, or that the driver's attention is intensified when the possibility or necessity of a take-over of vehicle control by the driver is detected.

In the following, all known cruise control systems or speed control systems including cruise control functions will be referred to as ‘adaptive cruise control’ systems or briefly ‘ACC’. Hence, all feasible cruise control systems such as ACC, AICC or ICC, but also subordinate speed control systems, are among these systems in the sense of the invention.

The object at issue is solved in that a possibility or a necessity that a driver of a vehicle takes over vehicle control is determined in the immediate future in an active cruise control system, and that it is pointed out to the driver that a take-over is imminent in the immediate future, or the driver's attention is intensified when the possibility or necessity of a take-over of vehicle control by the driver is detected.

More specifically, it is indicated in a most comfortable manner to the driver in a necessary or desirable and predictable driving situation that take-over by the driver is imminent in the immediate future, or rather his attention is augmented which might have been limited due to (long) ACC driving.

This ‘smooth’ announcement of take-over of speed control by the driver will impart to the driver a comfortable, yet reliable feeling in steering the vehicle.

It is arranged for by the invention that a driving situation is detected or predicted which renders a take-over of the vehicle control by the driver or enhanced attention of the driver in the immediate future likely or necessary.

It is provided by the invention that data or signals from a vehicle navigation system are taken into consideration in order to detect the possibility or necessity of a take-over of vehicle control by the driver.

According to the invention, a vehicle navigation system and an adaptive cruise control system take care of linking data.

It is arranged for by the invention that while the vehicle speed is included, a speed predetermined by the driver is not taken into account as a command variable for engine torque and/or brake torque requirement when a change of direction (turning maneuver) is imminent which requires the driver's attention.

The invention discloses that when an impending change of direction (turning maneuver) is detected which requires the attention of the driver, a special control mode is triggered that reduces the speed by a slow engine torque reduction.

It is provided according to the invention that, if an impending change of direction (turning maneuver) is detected which requires the driver's attention, automatic braking will be performed that preferably does not exceed a value of −0.1 g approximately, preferably depending on the vehicle speed and a distance from the point where a significant change of direction shall take place.

It is provided according to the invention that, if an impending change of direction (turning maneuver) is detected which requires the driver's attention, automatic braking will be performed which slows the vehicle down to a speed assigned to the current roadway, such as a motor highway or a country road, and/or achieves a reduction of vehicle speed that is noticeable to the driver, preferably depending on the vehicle speed and a distance from the point where a significant change of direction shall take place.

According to the invention, a possibility or a necessity that a driver of a vehicle takes over vehicle control in the immediate future is determined, if the possibility or necessity of take-over is impending within a period of the next 15 seconds (sec.) up to 140 seconds.

### BRIEF DESCRIPTION OF THE DRAWINGS

In the accompanying drawing:

FIG. 1 is a flow chart illustrating an embodiment of the invention.

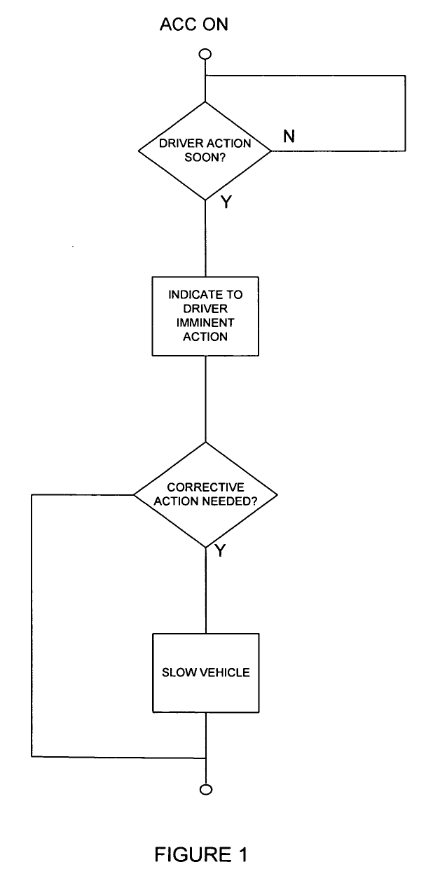

### DETAILED DESCRIPTION OF THE DRAWING

The invention will now be explained in detail by way of an embodiment.

A vehicle is equipped with a navigation system, an ACC system, and a means that allows detecting or predicting a situation which requires increased attention on the driver's part. Additional means is provided to comfortably alert the driver to such a situation. To render this possible, the navigation system and the ACC system are linked according to the invention.

To do so, a high-quality navigation system is e.g. employed which makes use of a large-surface display. This display is driven by way of a CAN-connection provided in the vehicle.

Thus, information about the route description or the type of route (marked by route identification such as A=motor highway, B=federal motor road, L=country road) are available on the CAN and can be read in by ACC. As an alternative or in addition, such information may also be available on a separate data transmission to the display and may then serve as a source for the data.

The instructions of changes of direction are also illustrated and, hence, are also available on the CAN (or any separate data transmission unit).

Moreover, the illustration of the change of direction reflects the rear course of the road and thus comprises also corresponding angular information. This angular information is not required to exactly correspond to the course of the road, but has to contain ‘only’ information relating to a trend such as a ‘sharp’ turning maneuver or an ‘insignificant’ change of direction.

Likewise, the distance from the point where the driver shall perform the turning maneuver will be indicated.

According to the invention, these pieces of information are provided individually or in a combination to the ACC system or to a speed control system in general. In addition, this information may also be supplied to an electronic brake control system, especially to a driving dynamics control unit (ESP).

When a change of direction (turning maneuver) is impending, which requires the attention of the driver, according to the invention, the speed predetermined by the driver is not taken into account as a command variable for engine torque and/or brake torque requirement, while the vehicle speed is included. Instead, a special control mode is triggered. Advantageously, the speed is then reduced by a slow engine torque reduction.

The term ‘change of direction’ in this case implies that the road is left on which the vehicle is currently driving, rather than cornering along the normal course of the road.

A particularly typical example in this respect is when the vehicle approaches the exit of a motor highway. Further, driving on a motor highway is also preferred for an active ACC control.

According to the invention, the speed is not automatically adapted to the entire course of the road, but the attention of the driver is only augmented after long ACC driving when it can be expected due to the information from the navigation system that a turning maneuver is impending.

Depending on the vehicle speed and the indication of distance from the point where a significant change of direction shall take place, it is also possible according to the invention that moderate braking is performed by the ACC system. This ‘moderate’ automatic brake operation should not exceed vehicle deceleration in a comfort range, this means a deceleration of preferably −0.1 g approximately.

According to the invention, the speed can be reduced to a speed assigned as a standard to the respective route, such as 100 km/h on motor highways or can produce a noticeable difference (e.g. 20 km/h) from the speed adjusted by the driver.

This special control mode differs from the homogeneous speed control and, according to the invention alerts the attention of the driver, thereby contributing to driving safety.

For special applications, the speaking function of the navigation system can be initiated in order to increase the attention of the driver.

According to the invention, the special control mode can also be triggered before the turning maneuver is shown on the display if corresponding information (about the route up to the point of turning) is available.

The driver does not consider this information as a malfunction or patronage because the special control mode reproduces the mode of driving of a foresighted driver, which enhances comfort and is plausible. This is because in most cases the vehicle speed is reduced accordingly simultaneously with a significant change of direction.

The special control mode is thus integrated into the ‘normal’ way of driving and is not disturbing. This is because the driver would have initiated the same driving maneuver by deactivating the ACC system (optionally by a short brake application).

1-9. (canceled)

10. A method of operating a motor vehicle cruise control system, the method comprising:
determining a possibility or a necessity that a driver of a vehicle takes over vehicle control in the immediate future; and
indicating to the driver that a take-over is imminent in the immediate future when the possibility or necessity of a take-over of vehicle control by the driver is detected.

11. A method according to claim 10, wherein data or signals from a vehicle navigation system are taken into consideration in order to determine the possibility or necessity of a take-over of vehicle control by the driver.

12. A method according to claim 10, wherein a vehicle navigation system and an adaptive cruise control system take care of linking data.

13. A method according to claim 10, wherein a change of direction is determined as the imminent action that will require the driver take over control of the vehicle, and a speed predetermined by the driver is not taken into account as a command variable for engine torque or brake torque requirement.

14. A method according to claim 10, wherein when an impending change of direction is detected which requires the attention of the driver is a turning maneuver, a special control mode is triggered that reduces a speed of the vehicle by a slow engine torque reduction.

15. A method according to claim 10, wherein when an impending change of direction is detected which requires the attention of the driver is a turning maneuver, an automatic braking will be performed that does not exceed a value of −0.1 g approximately, depending on a vehicle speed and a distance from a point where a significant change of direction shall take place.

16. A method according to claim 10, wherein when an impending change of direction is detected which requires the attention of the driver is a turning maneuver, automatic braking will be performed that slows the vehicle down to a speed assigned to a current roadway, such as a motor highway or a country road, or achieves a reduction of vehicle speed which is noticeable to the driver, depending on the vehicle speed and a distance from a point where a significant change of direction shall take place.

17. A method according to claim 10, wherein a possibility or a necessity that a driver of a vehicle takes over vehicle control in the immediate future is determined when the possibility or necessity of take-over is impending within a period of 15 seconds (sec.) up to 140 seconds.

18. A method of operating a motor vehicle cruise control system, the method comprising:
predicting a driving situation that makes a take-over of a vehicle control by a driver or an increased attention of the driver in the immediate future likely or necessary; and
indicating to the driver that a take-over is imminent in the immediate future when the possibility or necessity of a take-over of vehicle control by the driver is predicted.
